(19) United States
(12) Patent Application Publication
(10) Pub. No.: US 2009/0262385 A1
(43) Pub. Date: Oct. 22, 2009

(54) SYSTEM AND METHOD FOR SAVING AND LOADING USER CONFIGURATIONS FOR A MULTI-FUNCTION PERIPHERAL (MFP)

(75) Inventor: Nehal Dantwala, Newport Beach, CA (US)

Correspondence Address: KNOBBE, MARTENS, OLSON, & BEAR, LLP, 2040 MAIN STREET, FOURTEENTH FLOOR, IRVINE, CA, 92614, US

(73) Assignee: Samsung Electronics Co., Ltd., Suwon City (KR)

(21) Appl. No.: 12/104,307

(22) Filed: Apr. 16, 2008

(51) Int. Cl. G06F 15/00

(52) U.S. Cl. 358/1.15

(57) ABSTRACT

System and method for saving and loading user configurations for a multi-function peripheral are disclosed. In one aspect, a multi-function peripheral (MFP) comprises a storage unit having stored therein a software module. The MFP further comprises a control unit configured to execute the software module to a) retrieve a set of user configurations from a portable storage medium at the MFP, and b) load the retrieved user configurations to the MFP.

### BACKGROUND OF THE INVENTION

1. Field of the Invention

The invention relates to saving and loading user configurations for an electronic device. More particularly, the invention relates to saving and loading copy/print/scan settings for a multi-function peripheral.

2. Description of the Related Technology

There are many users who commonly rely on commercial copy centers such as Kinko's or Staples for their printing and copying needs. Each time when they use the machines, they need to manually adjust their copy/print settings. Also, these customers may have copy/print/scan settings that they repeatedly use for a particular task. In order to increase work efficiency, it is desirable to provide devices which allow individual users to store user preferences in a way such that the stored preferences may be shareable among multiple devices not connected to each other.

### SUMMARY OF CERTAIN INVENTIVE ASPECTS

The system, method, and devices of the invention each have several aspects, no single one of which is solely responsible for its desirable attributes. Without limiting the scope of this invention, its more prominent features will now be briefly discussed.

In one aspect, a multi-function peripheral (MFP) is disclosed. The MFP comprises a storage unit having stored therein a software module. The MFP further comprises a control unit configured to execute the software module to a) retrieve a set of user configurations from a portable storage medium at the MFP, and b) load the retrieved user configurations to the MFP.

In another aspect, a multi-function peripheral (MFP) is disclosed. The MFP comprises a storage unit having stored therein a software module. The MFP further comprises a control unit configured to execute the software module to a) receive a set of user configurations, and b) store the user configurations to a portable storage medium at the MFP.

In another aspect, a method of loading a set of user configurations into a multi-function peripheral (MFP) is disclosed. The method comprises retrieving a set of user configurations stored on a portable storage medium. The method further comprises loading the retrieved user configurations in the MFP.

In another aspect, a method of storing a set of user configurations into a multi-function peripheral (MFP) is disclosed. The method comprises receiving a set of user configurations. The method further comprises storing the user configurations to a portable storage medium at the MFP.

In another aspect, a multi-function peripheral (MFP) is disclosed. The MFP comprises means for retrieving a set of user configurations stored on a portable storage medium. The method further comprises means for loading the retrieved user configurations in the MFP.

In another aspect, a multi-function peripheral (MFP) is disclosed. The method comprises means for receiving a set of user configurations. The method further comprises means for storing the user configurations to a portable storage medium at the MFP.

In another aspect, a method of storing and loading a set of configurations for a multi-function peripheral (MFP) is disclosed. The method comprises storing a set of user configurations on a first MFP to a portable storage medium. The method further comprises loading the user configurations stored on the portable storage medium at a second MFP.

### BRIEF DESCRIPTION OF THE DRAWINGS

FIG. 1 is a diagram illustrating one embodiment of a multi-function peripheral (MFP).

FIG. 2 is a flowchart of one embodiment of a method of storing a set of user configurations for a MFP to a portable storage medium.

FIG. 3 is a flowchart of one embodiment of a method of loading a set of user configurations stored in a portable storage medium into a MFP.

FIG. 4 illustrates how a user operates an existing copy machine to make copies of a document.

FIG. 5 illustrates how a user operates a copy machine, allowing a user to store the user configurations on a portable storage medium, to make copies of a document.

### DETAILED DESCRIPTION OF CERTAIN INVENTIVE EMBODIMENTS

Various aspects and features of the invention will become more fully apparent from the following description and appended claims taken in conjunction with the foregoing drawings. In the drawings, like reference numerals indicate identical or functionally similar elements. In the following description, specific details are given to provide a thorough understanding of the disclosed methods and apparatus. However, it will be understood by one of ordinary skill in the technology that the disclosed systems and methods may be practiced without these specific details. For example, electrical components may be shown in block diagrams in order not to obscure certain aspects in unnecessary detail. In other instances, such components, other structures and techniques may be shown in detail to further explain certain aspects.

It is also noted that certain aspects may be described as a process, which is depicted as a flowchart, a flow diagram, a structure diagram, or a block diagram. Although a flowchart may describe the operations as a sequential process, many of the operations may be performed in parallel or concurrently and the process may be repeated. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Certain embodiments as will be described below include a multi-function peripheral which allows users to store user configurations in a portable storage medium and load the user configurations from the portable storage medium. In one embodiment, the MFP is able to store user configurations to barcodes printed on a paper sheet. When users wants to use the saved user configurations, the paper sheet printed with barcodes is feed to the MFP, which then retrieves the user configurations by decoding the barcodes. There are other options such as creating a digital configuration file and saving the same on a portable device such as a mobile phone, a universal serial bus drive, or a smartcard that may be swiped at the device. Though print/scan/copy settings are used as an example for illustration, these embodiments may be equally applied to other user configurations. Though multi-function peripherals are used as an example for illustration, these embodiments may be equally applied to any printer, copier, scanner, or other electronic devices.

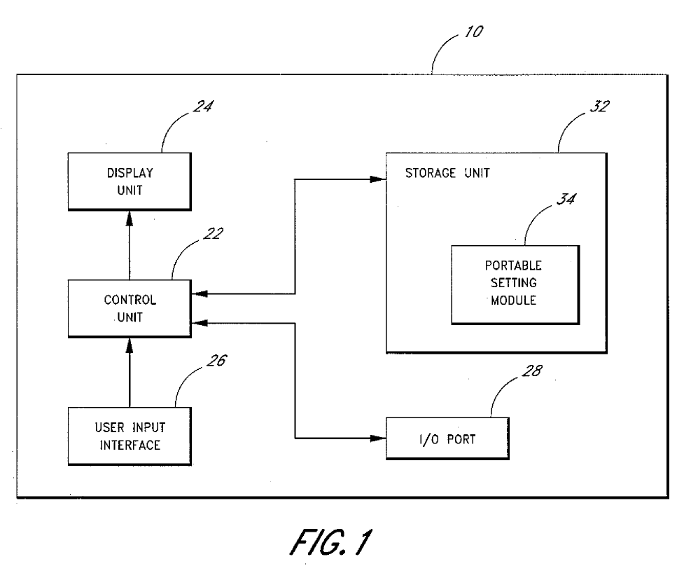

FIG. 1 is a diagram illustrating one embodiment of a multi-function peripheral (MFP). A multi-function peripheral (MFP) refers to an equipment that handles two or more of the following functions: printing, scanning, copying or faxing. A multi-function peripheral is also called a multi-function product, a multi-function printer, a multi-function device, and an All-in-One device etc.

The MFP 10 comprises a control unit 22 which controls the operation of the device such as printing, scanning, copying or faxing. In one embodiment, the control unit 22 is a processor which may be any suitable general purpose single- or multi-chip microprocessor, or any suitable special purpose microprocessor such as a digital signal processor, microcontroller, or a programmable gate array. As is conventional, the processor may be configured to execute one or more software applications.

The MFP 10 may further comprise a display unit 24 and a user input interface 26 that enable user interaction. The display unit 24 is used to communicate information, instructions, or data to a user. The user input interface 26 is configured to receive input data or instruction from a user. Both the display and the user input interface may be implemented in many forms and may contain multiple components.

In one embodiment, the display unit 24 may be, for example, a LCD. The user input interface 26 may include a keypad or keyboard. In other embodiments, the display unit 24 and the user input interface 26 may be integrated together in one device such as a touch screen as incorporated in a panel of certain copy machines.

The MFP 10 may further comprise an input/output (I/O) port 28 via which the control unit 22 may communicate to external devices such as a computer or portable storage medium. In one embodiment, the I/O port 28 may be any suitable input slot or interface, for example, a universal serial bus (USB) port, an input port for receiving a flash media device, or a smart card reader/write.

The MFP 10 may further comprise a storage device 32 to store data and software applications which the control unit 22 runs to control the operation of the MFP 10. The storage device 32 may be any suitable type of storage device such as a hard drive or a flash storage medium (e.g. a compact flash card).

In the exemplary embodiment, the storage device 32 has stored therein a portable setting software module 34, which may be executed by the control unit 22 to save user settings to a portable storage medium and retrieve user settings from the portable storage medium.

The portable storage medium may be any item that may be easily carried by a user and that may store the user configurations. Depending on the portable storage medium used, the MFP 10 may further comprise one or more units via which the control unit may save user configurations to the portable storage medium and retrieve user configurations from the portable storage medium.

In the exemplary embodiment, the portable storage medium may be a sheet of paper printed with barcodes representing the user configurations. The MFP 10 may further comprise a scan unit configured to scan the barcodes on the paper into an electronic image. The control unit 22 is configured to decode the image of the barcodes and retrieve the user configurations stored therein. The MFP 10 may further comprise a print unit configured to print barcodes on a paper. The control unit 22 is configured to generate barcodes storing the user configurations and print the generated barcodes on a paper.

The user configurations may also be stored as a computer-readable digital configuration file and saved on a portable data storage medium or electronic device. The portable electronic device may be, for example, a mobile phone, a portable music player, or a personal data assistant. The portable data storage medium may be, for example, an external hard drive, a floppy disk, a flash storage medium, or an optical storage medium. The control unit 22 communicates with the portable data storage medium or electronic device via the input/output port 28, thus storing and retrieving user configurations.

In one embodiment, the portable storage medium may be a smart card. The MFP 10 may further comprise a smart card reader/writer via which the control unit 22 may store user configurations to and retrieve the same from the smart card.

The portable storage medium may be used to store any user configurations for the MFP 10. The user configurations may include any settings related to copying, printing, or scanning. The copy setting may include, but are not limited to, one or more of the following: darkness level, paper type, paper size, zoom ratio, number of copies, auto background erasure, and one/two sided. The print setting may include, but are not limited to, one or more of the following: darkness level, paper type, paper size, zoom ratio, number of copies, auto background erasure, and one/two sided. The scan settings may include, but are not limited to, one or more of the following: destination, document name, metadata, autoexposure, color mode, compression quality, contrast, darkness, sharpness, resolution, document image mode, input edge erase, input media size, image orientation, output image size, magnification, sides to scan, document format.

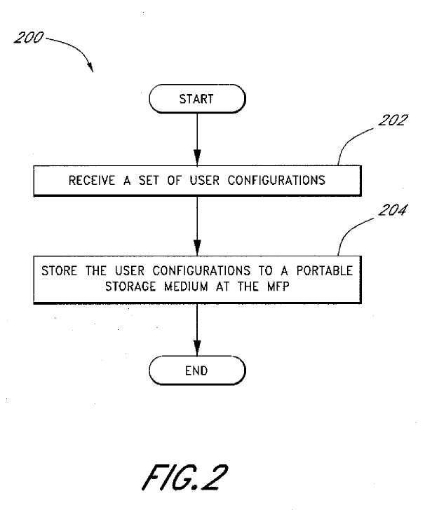

FIG. 2 is a flowchart of one embodiment of a method of storing a set of user configurations for a MFP to a portable storage medium. Depending on the embodiment, certain steps of the method may be removed, merged together, or rearranged in order. The method 300 may be performed by, for example, by the control unit 22 running the portable settings software module 34 stored in the storage unit 32 in FIG. 1.

The method 200 begins at a block 202, wherein the MFP 10 receives a set of user configurations for the MFP. The user configurations may include, for example, any settings related to copying, printing, or scanning. In the exemplary embodiment, the MFP 10 receives the user configurations from a user who manually enters the user configurations using the user input interface 26 of the MFP 10. In other embodiments, a user may also direct the MFP 10 to load a set of user configurations stored on the storage unit 32 of the MFP 10.

Moving to block 204, the MFP 10, based on user instructions, stores the user configurations as received to a portable storage medium for future use. In one embodiment, the MFP 10 asks the user whether he/she wants to save the current user configurations into a portable storage medium after receiving user configurations. The portable time may be any suitable item that may be easily carried by a user and that may store the user configurations.

In one embodiment, the portable storage medium may be a sheet of paper. The control unit 22 of the MFP 10 generates barcodes to represent the user configurations and causes the barcodes to be printed on the paper sheet. In another embodiment, the control unit 22 of the MFP 10 creates a computer-readable file comprising the user configurations, and then stores the computer-readable file to a portable data storage medium or a portable electronic device, which is locally connected to the MFP 10 via the input/output port 28. In another embodiment, the control unit 22 stores the computer-readable file to a smart card via a smart card writer.

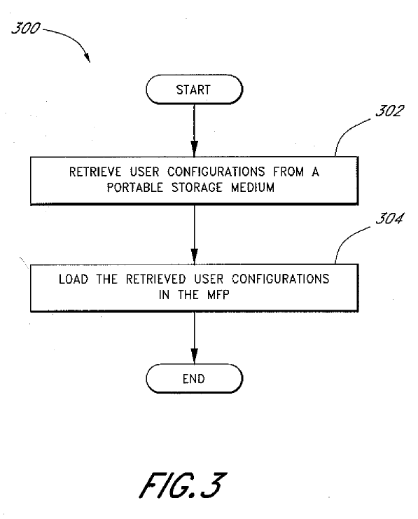

FIG. 3 is a flowchart of one embodiment of a method of loading a set of user configurations stored in a portable storage medium into a MFP. Depending on the embodiment, certain steps of the method may be removed, merged together, or rearranged in order. The method 300 may be performed by, for example, by the control unit 22 running the portable settings software module 34 stored in the storage unit 32 in FIG. 1. Prior to the method 300, a portable storage medium has been created at a MFP 10 following the process of FIG. 2.

The method 300 begins at a block 302, wherein the MFP 10 receives a portable storage medium comprising a set of configurations for the MFP from a user and retrieves the user configurations from the portable storage medium based on user instructions. The user may control the MFP 10 via the user input interface 26 of the MFP 10. The user configurations may include, for example, any settings related to copying, printing, or scanning. The portable time may be any suitable item that may be easily carried by a user and that may store the user configurations.

In one embodiment, the MFP 10 receives a sheet of paper printed with barcodes comprising the user configurations. The MFP 10 scans the barcodes on the paper sheet into an electronic image. The control unit 22 then decodes the image of the barcodes to retrieve the user configurations stored therein.

In another embodiment, the portable storage medium is a portable data storage medium or a portable electronic device connected to the MFP 10 via the input/output port 28. The portable data storage medium or portable electronic device has stored therein a computer-readable file comprising the user configurations. The control unit 22 reads the computer-readable file from the portable data storage medium or portable electronic device and then retrieves the user configurations.

In another embodiment, the portable storage medium is a smart card having stored therein a computer-readable file comprising the user configurations. The control unit 22 reads the computer-readable file from the smart card via a smart card reader locally attached to the MFP 10, and then retrieves the user configurations.

Moving to a block 304, the control unit 22 loads the retrieved user configurations to the MFP 10. A user may then operate the MFP 10 using the retrieved user configurations, or make further changes to the configurations.

The foregoing embodiments provide a way to store user configurations shareable among multiple devices which are not connected to each other. They may be used in various applications to increase work efficiency by allowing a user to store customized user configurations on a portable storage medium (e.g., a paper sheet printed with barcodes) and loading the user configurations from the portable storage medium for later use at the same device or a different device.

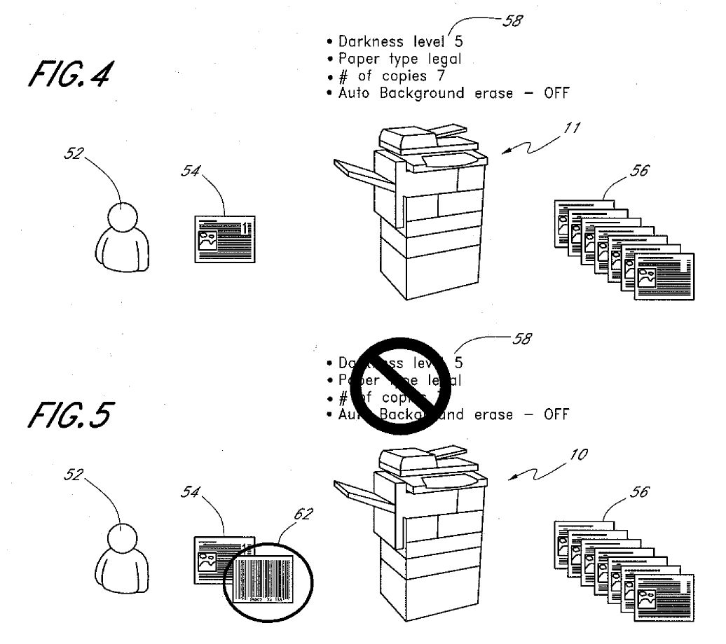

FIG. 4 and FIG. 5 are diagrams illustrating how the foregoing embodiments increase users' work efficiency in an exemplary work scenario. In this example, a user 52 has copying needs that require him/her to go to commercial copy centers such as Kinko's on a daily basis. The user 52 needs to make seven copies 56 of a company invoice 54. The user 52 is used to use the same copy machine at a particular Kinko's location or at least the same type of copy machine that Kinko's offers at all their locations. Since the company invoice 54 is printed on yellow slip, it requires the following copy settings 58:
Darkness level 5
Paper type legal
# of copies 7
Auto. Background erase—OFF

FIG. 4 illustrates how a user makes copies of a document using an existing copy machine. The user 52 walks to a copy machine 11 in the copy center and manually adjusts the copy settings. The user 52 then makes copies and walks away. Next time the user 52 wants to make copies of another company invoice 54 at the same copy center or a copy center at a different location, the user has to repeat the same process.

FIG. 5 illustrates how a user makes copies of a document using a copy machine allowing him/her to store the user configurations on a portable storage medium. For example, the copy machine may be the MFP 10 as described above with regard to FIG. 1. The user 52 walks to a MFP 10 in the copy center, manually adjusts the copy settings, and makes copies. Upon completion of making copies, the user 52 is asked whether he/she wants to save the settings for future use. The user 52 then instructs the MFP 10 to print a paper sheet 62 printed with barcodes storing the user configurations. The user 52 takes the paper sheet 62 with printed barcodes with him/her and leaves the store.

Next time the user 52 wants to make copies of another company invoice 54 at the same copy center, the user brings the paper sheet 62 with printed barcodes with him/her to the store. The user 52 puts the paper sheet 62 on the top of his/her document stack. The MFP 10 interacts with the user 52 to load the user configurations from the barcodes on the paper sheet 62 and to apply the user configurations to make copies of the company invoice 54. If the user 52 needs to use a Kinko's at a different location to make copies of the company invoice 54 for some reason, he/she can follow the same process to load the user configurations to the MFP 10 and then make copies using the loaded user configurations. The user configurations stored on the paper sheet 62 printed with barcodes may be loaded to multiple MFPs 2 which are not connected to one another.

As shown in FIG. 5, the MFP 10 provides a user the ability to store the user configurations on a portable storage medium for further use and load the user configurations from the portable storage medium. A user does not need to manually adjust the settings to the same set of settings each time he/she uses the MFP 10.

One of the foregoing embodiments addresses users' need to store a set of customized print/copy/scan settings for a particular job that they repeatedly perform at various copy center locations. The embodiment provides users with a paper sheet printed with barcodes comprising the customized print/copy settings. Therefore, users may load the user configurations at different devices as far as these devices support the function of loading the user configurations from a paper sheet printed with barcodes. These devices do not have to be connected to one another via network or be at the same location.

Other embodiments provide users with another portable storage medium to carry the customized print/copy/scan settings. The customized settings may be stored in, for example, a computer-readable file. The portable storage medium may be, for example, a portable data storage medium, a portable electronic device, and a smart card. The MFP stores the customized settings to and retrieves the same from the portable storage medium locally attached via an appropriate input/output port.

Various embodiments of a method are described above, including, e.g., a method of storing and loading user configurations in a portable storage medium. In one embodiment, a software program may be stored in a computer-readable medium. The software program, when being executed by a computer, performs the method.

The foregoing embodiments relate to storing and loading user configurations in a portable storage medium. Though print/scan/copy settings are used as an example for illustration, these embodiments may be equally applied to other user configurations. Though multi-function peripherals are used as an example for illustration, these embodiments may be equally applied to any printer, copier, scanner, or other electronic devices.

The foregoing description details certain embodiments of the invention. It will be appreciated, however, that no matter how detailed the foregoing appears in text, the invention may be practiced in many ways. It should be noted that the use of particular terminology when describing certain features or aspects of the invention should not be taken to imply that the terminology is being re-defined herein to be restricted to including any specific characteristics of the features or aspects of the invention with which that terminology is associated.

While the above detailed description has shown, described, and pointed out novel features of the invention as applied to various embodiments, it will be understood that various omissions, substitutions, and changes in the form and details of the device or process illustrated may be made by those skilled in the technology without departing from the spirit of the invention. The scope of the invention is indicated by the appended claims rather than by the foregoing description. All changes which come within the meaning and range of equivalency of the claims are to be embraced within their scope.

What is claimed is:

1. A multi-function peripheral (MFP) comprising:
a storage unit having stored therein a software module; and
a control unit configured to execute the software module to retrieve a set of user configurations from a portable storage medium at the MFP; and
load the retrieved user configurations to the MFP.

2. The MFP of claim 1, wherein the user configurations comprises a set of copy settings.

3. The MFP of claim 2, wherein the copy settings comprise at least one of the followings: darkness level, paper type, paper size, zoom ratio, number of copies, auto background erasure, and one/two sided.

4. The MFP of claim 1, wherein the user configurations comprises a set of scan or print settings.

5. The MFP of claim 4, wherein the print settings comprise at least one of the followings: darkness level, paper type, paper size, zoom ratio, number of copies, auto background erasure, and one/two sided.

6. The MFP of claim 1, wherein the portable storage medium is a sheet of paper printed with barcodes, wherein the control unit is configured to decode the barcodes and retrieve the set of user configurations stored in the barcodes.

7. The MFP of claim 1, wherein the portable storage medium is a portable electronic device, wherein the MFP further comprising an input/output port via which the control unit is configured to read a computer-readable file from the portable electronic device, the computer-readable file storing the user configurations.

8. The MFP of claim 1, wherein the portable storage medium is a smart card storing a computer-readable file comprising the user configurations, wherein the MFP further comprising a smart card reader via which the control unit is configured to read the computer-readable file from the smart card.

9. The MFP of claim 1, wherein the portable storage medium is a flash storage medium storing a computer-readable file comprising the user configurations, wherein the MFP further comprising an input/output interface via which the control unit is configured to read the computer-readable file from the flash storage medium.

10. A multi-function peripheral (MFP) comprising:
a storage unit having stored therein a software module; and
a control unit configured to execute the software module to:
receive a set of user configurations; and
store the user configurations to a portable storage medium at the MFP.

11. The MFP of claim 10, wherein the user configurations comprise a set of copy or print or scan settings.

12. The MFP of claim 10, wherein the portable storage medium is a sheet of paper, and wherein the control unit is configured to print barcodes on the paper storing the user configurations.

13. The MFP of claim 10, the MFP further comprising an input/output port, wherein the portable storage medium is a portable electronic device, wherein the control unit is configured to store a computer-readable file comprising the user configurations to the portable electronic device via the input/output port.

14. The MFP of claim 10, wherein the portable storage medium is a smart card, wherein the MFP further comprising a smart card writer via which the control unit is configured to store a computer-readable file comprising the user configurations into the smart card.

15. The MFP of claim 10, wherein the portable storage medium is a flash storage medium or a universal serial bus (USB) device, wherein the MFP further comprising an input/output interface via which the control unit is configured to store a computer-readable file comprising the user configurations to the flash storage medium or USB device.

16. A method of loading a set of user configurations into a multi-function peripheral (MFP), comprising:
retrieving a set of user configurations stored on a portable storage medium; and
loading the retrieved user configurations in the MFP.

17. A computer-readable medium having stored therein a program, when being executed by a computer, configured to perform method of claim 16.

18. The method of claim 16, wherein the user configurations comprise a set of copy or print or scan settings.

19. A method of storing a set of user configurations into a multi-function peripheral (MFP), comprising:
receiving a set of user configurations; and
storing the user configurations to a portable storage medium at the MFP.

20. A computer-readable medium having stored therein a program, when being executed by a computer, configured to perform method of claim 19.

21. The method of claim 19, wherein the user configurations comprise a set of copy or print or scan settings.

22. A multi-function peripheral (MFP), comprising:
means for retrieving a set of user configurations stored on a portable storage medium; and
means for loading the retrieved user configurations in the MFP.

23. A multifunction peripheral (MFP), comprising:
means for receiving a set of user configurations; and
means for storing the user configurations to a portable storage medium at the MFP.

24. A method of storing and loading a set of configurations for a multi-function peripheral (MFP), the method comprising:
storing a set of user configurations on a first MFP to a portable storage medium; and
loading the user configurations stored on the portable storage medium at a second MFP.

25. The method of claim 24, wherein the first MFP is different from the second MFP.
